(19) United States
(12) Patent Application Publication
(10) Pub. No.: US 2007/0244800 A1
(43) Pub. Date: Oct. 18, 2007

(54) Work allocation system

(76) Inventors: Habin Lee, Ipswich (GB); John Shepherdson, Sudbury (GB)

Correspondence Address: NIXON & VANDERHYE, PC, 901 NORTH GLEBE ROAD, 11TH FLOOR, ARLINGTON, VA, 22203, US

(21) Appl. No.: 11/723,973

(22) Filed: Mar. 22, 2007

(30) Foreign Application Priority Data
Mar. 30, 2006 (EP) 06251782.6

(51) Int. Cl. G06Q 40/00

(52) U.S. Cl. 705/37

(57) ABSTRACT

A method for allocating service providers to a set of required services, each service provider being associated with a respective bidding entity and the method comprising repeatedly performing the following steps: receiving at least one bid from each of some or all of the bidding entities, each bid specifying one or more of the required services and indicating a bid value; accepting bids that specify no services that are specified in any other bids; for any sets of bids that specify one or more of the same services, selecting one of those bids in dependence on the bid values specified in each bid of the set, and accepting the selected bid; and removing the services specified in accepted bids from the list of required services.

This invention relates to the field of work allocation systems: that is systems for assigning (“dispatching”) work, tasks or more generally services or requested/required services to one or more entities (“process actors”) that are to perform each service.

Distributed scheduling methods (DSMs) offer advantages over centralised scheduling methods (CSMs). First, DSM offers a powerful tool to resolve a large number of scheduling conflicts (see Graves, S. C., A Review of Production Planning, Operations Research, Vol 29, No 4, pp 647-675). Second, DSMs using auction-based mechanisms are robust in resolving conflicts, are efficient in allocating scarce resources such as heat, and ATM network bandwidth, and have an adaptive design (see Tan, Jui Chiew; Harker, Patrick T. Designing Workflow Coordination: Centralized Versus Market-Based Mechanisms, Information Systems Research, December 1999, Vol. 10 Issue 4, p 328, 15 p.). Last but not least, the advantage of DSMs is emphasised when managers want to implement incentive mechanisms for their workforces. For example, if field engineers receive bonuses based on points that can be obtained by executing certain types of task, then a CSM is not an ideal solution because there is then no way for the engineers to express a preference for the tasks they want to execute without either submitting no bids for less-preferred tasks or by submitting more costly bids for less-preferred tasks. Both of those options can result in a task being performed at more costly rate than could be possible under a more intelligently applied system.

While DSMs have largely been discussed in academic circles, centralised scheduling methods (CSM) have been widely used in real situations. For example, British Telecommunications plc has used a centralised workforce scheduling system since 1997 (see David Lesaint, Christos Voudouris, and Nader Azarmi, Dynamic Workforce Scheduling for British Telecommunications plc., Interfaces, Vol 30, No 1, pp. 45-56, 2000). One reason for the limited usage of DSMs is that the infrastructure generally needed for the implementation of DSMs is not yet mature. For example, multi-agent systems and peer-to-peer computing technology, which are anticipated to be the best technology for implementing DSMs, have not yet become widely and readily available in the commercial market.

Tan and Harker (1999) revealed that DSM shows better performance in workflow coordination over CSM in a situation where information technology is cheap, processing time is relatively long, and the pool of agents is not large (See Tan, Jui Chiew; Harker, Patrick T. Designing Workflow Coordination: Centralized Versus Market-Based Mechanisms, Information Systems Research, December 1999, Vol. 10 Issue 4, p 328, 15 p).

EP 1 310 886 discloses one example of the use of DSM: for booking-based work assignment. In that system workers can book the work they want to execute for each working day from a central work pool that maintains all the work that should be collectively executed by the members of a team. However, that system does not account for incentives that may be applied to the execution of each work item. In that system each individual is supposed to select work based on their current location and skill sets. This may not yield an optimal solution to the allocation problem.

WO 02/080055 proposes a mediator-based work allocation system. In that system, a mediator agent represents a team of workers and interacts with an OSS agent that maintains all the work that should be performed by the teams to get work for the team via a Contract-Net Protocol. In that system the mediator agent bids on behalf of an individual worker, not a group of workers. As a result, that system can not be used for an incentive based work allocation in which workers in the same team compete with each other to maximise their bonus points by executing work.

A significant disadvantage of a centralised allocation method (CAM) for allocating tasks to human workers arises from the principle known as moral hazard. Because the workers come to rely on the system they become less pro-active, and as a result the standard of work can suffer. For example, a CAM-based allocation system would normally be configured to avoid generating work schedules that are too tight, in case a worker might be unable to finish one task before he is due to start the next. A result of this would be expected to be that the workers do their jobs more slowly than they need to, since they know they do not need to finish each job until the time expected by the system. As a result of this, organisations that have up to now operated a CAM scheme are starting to consider alternative mechanisms that will allow workers to be involved in the allocation process, and will give incentives to increase productivity.

There is a need for a system that permits an organisation to readily implement a market-based work allocation system that reduces the influence of moral hazard. It should preferably implement an incentive mechanism whereby process actors such as engineers can influence their own service commitments so as to allow them to be influenced by incentives that may be implemented.

According to one aspect of the present invention there is provided a method for allocating service providers to a set of required services, each service provider being associated with a respective bidding entity and the method comprising repeatedly performing the following steps: receiving at least one bid from each of some or all of the bidding entities, each bid specifying one or more of the required services and indicating a bid value; accepting bids that specify no services that are specified in any other bids; for any sets of bids that specify one or more of the same services, selecting one of those bids in dependence on the bid values specified in each bid of the set, and accepting the selected bid; and removing the services specified in accepted bids from the list of required services.

According to a second aspect of the present invention there is provided a system for allocating service providers to a set of required services, each service provider being associated with a respective bidding entity, the system comprising an allocation unit configured to repeatedly perform the following steps: receiving at least one bid from each of some or all of the bidding entities, each bid specifying one or more of the required services and indicating a bid value; accepting bids that specify no services that are specified in any other bids; for any sets of bids that specify one or more of the same services, selecting one of those bids in dependence on the bid values specified in each bid of the set, and accepting the selected bid; and removing the services specified in accepted bids from the list of required services.

The said steps of receiving, accepting, selecting and removing are preferably performed by a data processing unit, such as a computer. Each bidding entity may operate under the control of a mobile communication unit. The bidding entities may be connected to the data processing unit by first communication means that are more reliable than second communication means by means of which the mobile communication units can communicate with the bidding entities. The second communication means may comprise a wireless communication link. The first communication link may include no wireless communication link; it may be an exclusively wired link.

The step of selecting one of the bids of a set in dependence on the bid values specified in each bid of the set may comprise determining which of the bids of the set specifies a bid value closest to a pre-set limit value and accepting that bid. That value may be an upper value (e.g. an infinitely high value) or a lower value (e.g. zero or an infinitely low value). The choice of limit may be made in accordance with the incentive system that is in use.

The method may comprise rewarding each service provider in dependence on the bid values specified in accepted bids received from the bidding entity associated with the respective service provider.

The method may comprise the steps of: allocating a service value to each of the required services; and rewarding each service provider in dependence on the service values of the services performed by the respective service provider.

The method may comprise storing information representing attributes of each service provider. Then, the step of selecting one of the bids of a set is preferably performed in dependence also on the attribute information stored for each of the service providers associated with the bidding entities that submitted the bids of the set.

Conveniently each bidding entity is independently configurable to, on receiving a request for a bid, automatically form a bid in accordance with a bidding algorithm supplied to it. That algorithm may specify one or more specific services to be specified and/or a specific bid value. Alternatively it may specify a mechanism for selecting services to be specified and/or a method for determining a bid value. Preferably, the method comprises: receiving at a bidding entity a list of required services; the bidding entity automatically selecting at least some of those services in accordance with the bidding algorithm supplied to it; the bidding entity determining a bid value in dependence on the selected services and the bidding algorithm; and the bidding entity transmitting a bid specifying the selected services and indicating the determined bid value.

The allocation unit may store information representing attributes of each service provider. It may be configured to select one of the bids of a set in dependence also on the attribute information stored for each of the service providers associated with the bidding entities that submitted the bids of the set.

The present invention will now be described by way of example with reference to the accompanying drawings.

In the drawings:

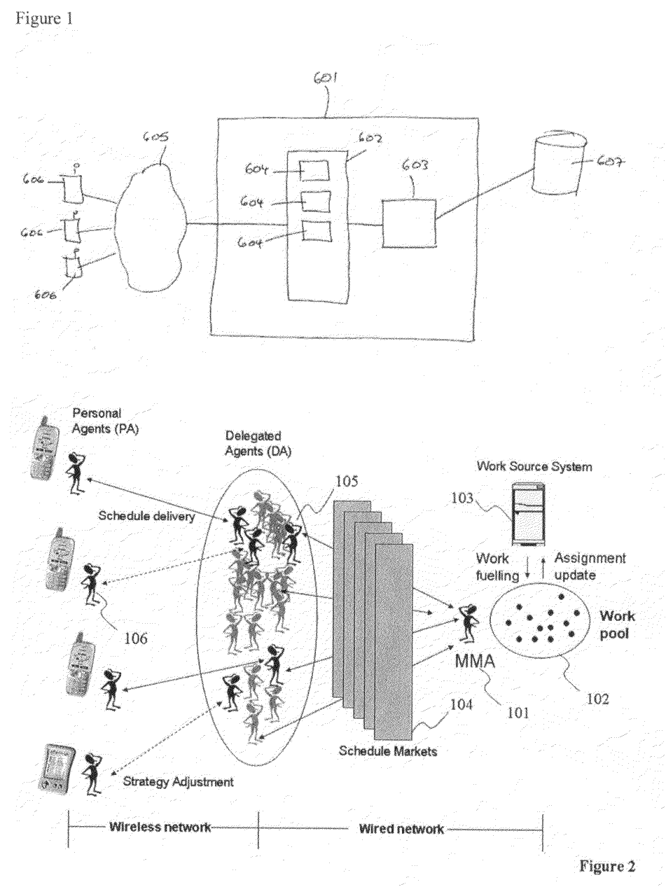

FIG. 1 shows a simplified overall architecture of the present system;

FIG. 2 shows in more detail the overall architecture of the present system;

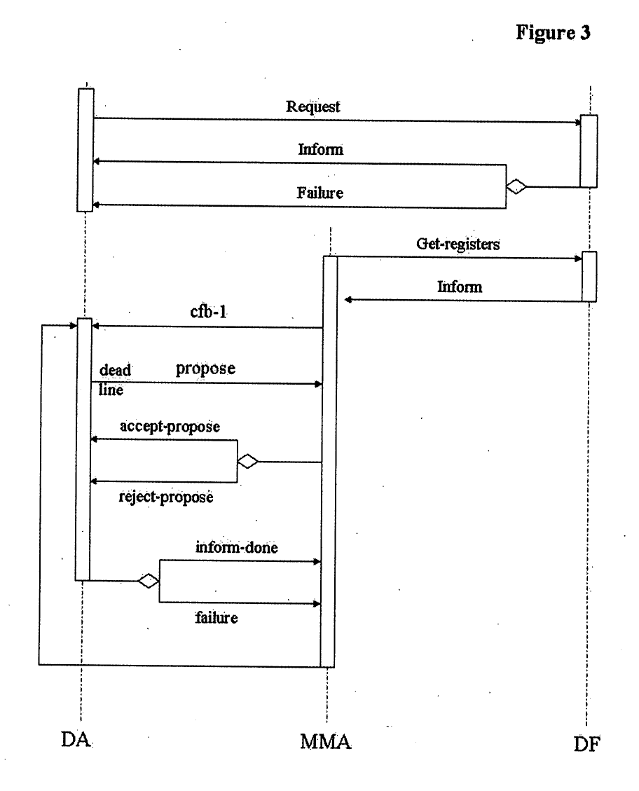

FIG. 3 is a sequence diagram showing message sequences between a market manager and participating delegated agents;

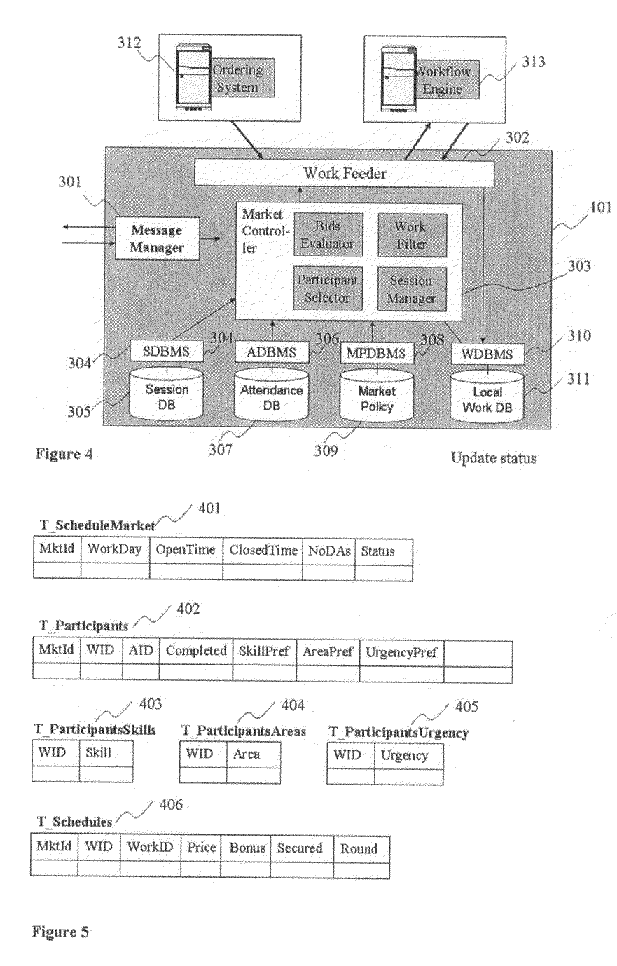

FIG. 4 shows the architecture of a market manager for starting a new market and coordinating bidding procedures;

FIG. 5 shows an example table structure to store information with regard to the operation of a schedule market;

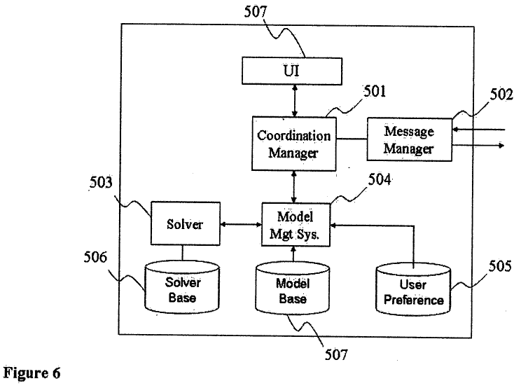

FIG. 6 shows an internal architecture of a delegated agent;

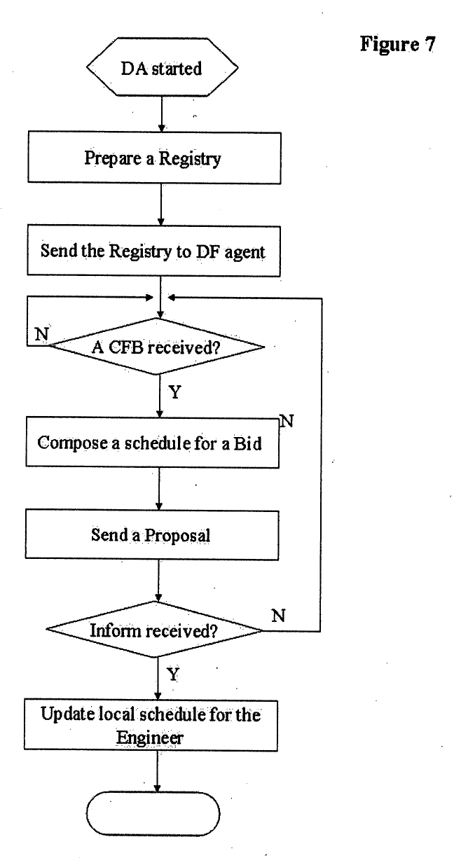

FIG. 7 shows the flow chart of steps in the market manager for the coordination of a work distribution market; and

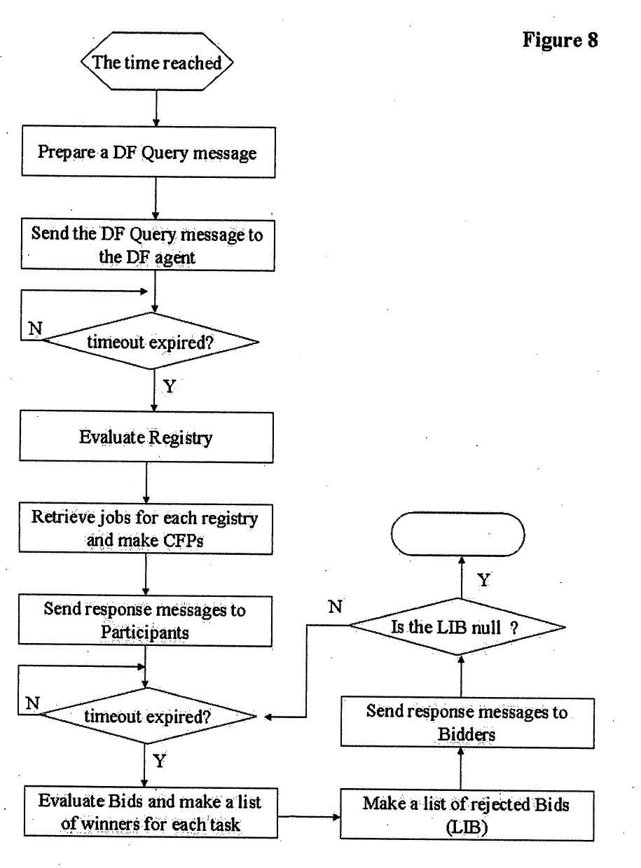

FIG. 8 shows the flow chart of the operation of a delegated agent.

FIG. 1 illustrates the architecture of a system for implementing the present work allocation mechanism. The system comprises an allocation processing section 601, a work item database 607 and a series of user terminals 606. The user terminals can communicate with the allocation processing section via a network 605. The work item database 607 stores a set of work items that are to be allocated to users of the system. Each such user has a user terminal 606 which he uses for placing bids to carry out the work items. The bids are analysed by a bid allocation engine 603, which decides which bids to accept. When a bid is accepted the user whose bid was accepted is informed that he has been allocated the work item, and the database 607 is updated to show that the item has been allocated to that user.

The user terminals 606 could communicate with the allocation engine 603 without any intermediary. However, it is preferred that each user terminal communicates with the allocation engine via a respective delegated agent 604, which is programmed with a bidding strategy by the respective user terminal and makes bids on behalf of the user terminal. In this way bids can be submitted on behalf of the user terminal even if the user terminal itself is temporarily unable to communicate with the allocation processing section 601.

The bidding process is iterative and consists of a series of rounds. In each round bids are solicited by the allocation engine 603, which provides the agents 604 and/or the terminals 606 with access to the list of work items on which bidding is taking place. An individual bid can then be submitted on behalf of each of the users of the terminals 606. Each bid includes a specification of one or more of the work items on which bidding is taking place and an identification of a bid value. That could represent an actual monetary value representing an amount that the bidder is willing to pay to perform the specified work items or it could represent a notional points value that can later be used for calculating reward or measuring performance. The bids are collected by the allocation engine 603, which applies a pre-stored routine to decide which bids to accept. The routine uses the indicated values to resolve conflicting bids.

In one example of such a routine, first any bids that relate solely to work items that are not the subject of any other bids are accepted. The remaining bids conflict with one or more other bids. Each set of mutually conflicting bids is considered in turn, and of those the one that bids the greatest value (or the least value if the sense of the values is reversed) is accepted. Other mechanisms can be used to further resolve conflicts in the event of equal amounts being bid.

The bidding and allocation process is then repeated as necessary. Any work items that were accepted in previous rounds are not made available for bidding in subsequent rounds. Once the process is complete the users of the terminals 606 are informed of whether they have made an accepted bid, and if so which work item(s) they are engaged to perform. The database 607 is updated accordingly.

When the bid values are notional values they can be used to measure performance, for example by rewarding the users more the fewer (or if the sense of the values is reversed the more) points they accumulate over a period of time. The users may be issued with a limited number of points that they can use to bid over a period of time. The users may be rewarded in dependence also on the significance of the work items they complete. In that latter situation the present system provides a particularly efficient means for market-based allocation of work to the users, since the users must make a trade-off between the value they are prepared to bid for each item of work (which is inversely linked to their reward) and the value of completing each item of work (which is directly linked to their reward).

The present system may be used as a market-based work allocation system for allocating work items to engineers. In such a system each engineer in a team can compose a personal schedule to maximise his reward. In this market-based system, each work item is assigned a bonus point value. Each engineer accumulates the bonus point values of the tasks that he completes. Each engineer can compose a work schedule (a series of work items to be executed by him) for the next working-day by bidding for desired work items at prices (potentially virtual prices) he is willing to pay to secure the work from other engineers. A market controller resolves any conflicts among different engineers who want to have the same work item in their work schedules. A market policy that guides and regulates the behaviour of the engineers (as market actors) is provided to the market controller and can be updated from time to time.

The implementation of the market-based work allocation system is based on the use of a multi-agent system. This can reduce the need for human workers to intervene in the coordination process to compose schedules for the workers. Three types of agents are used: a personal agent (PA), a delegated agent (DA), and a market management agent (MMA).

The MMA plays a market controller role. It is responsible for the management of a work pool that contains all the work that should be completed by a team of engineers. It also makes a market in which all the engineers participate to compose their work schedules to maximise their bonus points. The operation of the market is based on iterative bidding composed of multiple rounds. In each round, all participating engineers will submit a bid to the MMA. Each bid takes the form of a work schedule identifying the items of work that the respective engineer offers to carry out. The MMA that will evaluate the received work schedules to see if there are any conflicts (i.e. the same item of work being identified in more than one work schedule) among them. If there are any such conflicts, the MMA will decide on which of the engineers who identified the conflicting item of work in their work schedules will be allocated that item of work. That decision will be made using pre-defined business rules: for example, awarding the work to the highest priced one of the conflicting work schedules (in the case where the prices represent payments or virtual payments from the engineers). The MMA may exclude bids that fail to meet certain terms: for example bids that exceed certain time or cost specifications. All other bids, including those awarded following conflict resolution, are accepted. All the items of work included within accepted bids are removed from the work pool. Then the next round of the market (in which those engineers whose schedules have been accepted in an earlier round do not take part) takes place. A market is completed when all the participating engineers have had a work schedule accepted, or all available items of work have been allocated.

A PA is conveniently, but not necessarily, implemented on a mobile device that can be carried by an engineer. The PA automates most of the activities required in the negotiation process with MMA to compose a work schedule for the engineer. A PA may delegate some activities for the negotiation process to a DA that is located within a corporate network. This may address problems that can arise if the mobile device frequently loses connection with the MMA, as may happen in some mobile communication networks.

A DA will represent the interest of an engineer in the composition of their work schedule in a market that has been opened by a MMA. The composition of a work schedule for the engineer will be based on the strategies (or rules) specified by the engineer. A PA will interact with its DA to change the strategies.

As shown in FIG. 2, the implementation of the market-based work allocation system is based on a multi-agent system. Three types of agents are used: market management agent (MMA) 101, delegated agent (DA) 105, and personal agent (PA) 106.

A MMA 101 plays a market controller role. It is responsible for the management of a work pool 102 that contains all the work items that are required to be completed by a team of engineers. The work of the MMA may include gathering work items from work source systems (e.g. ordering systems or workflow management system), and updating the owner of the work item after the work item has been successfully allocated to an engineer. It also opens a schedule-market 104 in which all the engineers participate as described above to compose their work schedules.

A PA 106 is installed on a mobile device that is carried by an engineer and it automates most of the activities required in the negotiation process with MMA 101 to compose a work schedule for the engineer. A PA 106 may delegate some or all activities for the negotiation process to a DA 105 that is located within a LAN-based corporate network. The purpose of the DAs 105 is to reduce the necessary traffic over the wireless network and to allow handling of any exceptions without recourse to the DAs. As PAs 106 are located on mobile devices (which might fail due to running out of power or might be out of range), they might not always be connected to the MMA. This could cause problems handling any changes that are to be made to a schedule, for example to accommodate conflicts or emergency work items. For this reason the PAs 106 provide services at the presentation layer and the DAs 105 provide services at the logic layer that are related to market-based works allocation. A DA 105 will represent the interest of an engineer in the composition of his work schedule in a schedule market 104 that has been opened by a MMA 101. The composition of a work schedule for the engineer will be based on the strategies (or rules) specified by the engineer. A PA 106 will interact with its DA 105 to change the strategies. On the other hand, a DA 105 will interact with a MMA 101 to compose a work schedule 104 for the human user or to change the attendance schedule of the user.

A schedule market is a virtual market wherein DAs 105 compose their schedules on behalf of human workers by communicating with a MMA 101. Schedules may be composed for a defined period, such as a working day. As an example, an MMA may create an instance of a schedule market during non-working time (for example, after 6:00 pm and before 6:00 am) daily.

FIG. 4 shows the internal architecture of a MMA 101. On the creation of a schedule market instance, the MMA 101 may create a list of engineers who are to participate in the bidding process for the next day. This list may take into account scheduled absences, by omitting from the process engineers who are scheduled to be absent. Then, the MMA may prepare a list of the work items that should be assigned to the participants for the target working day. For this purpose the MMA 101 may retrieve jobs that should be completed on the designated working day for the market from a local work database 311.

FIG. 3 is an interaction protocol diagram that shows the sequence of messages between participating agents in the operation of a schedule market 104. Before a schedule market is instantiated, each participating DA 105 may subscribe its availability on each working day and indicate a preference that may be used by MMA to retrieve candidate work items for the DA 105 to a directory facilitator entity (DF), which is responsible for a directory service. In a specific implementation of this invention, the subscribe message may take following form.

```
(Request
:sender (agent-identifier :name da-eahbl00@mobile.com)
:receiver (set (agent-identifier :name df@test.com))
:language FIPA-SL0
:protocol FIPA-Request
:ontology IncentiveBasedWorkAllocation
:content (action (update-preference
    :WID eahbl00
    :AID da-eahbl00@mobile.com
    :available 10-01-2006 11-01-2006 13-01-2006 14-01-2006
    :areas PAQ-132-AQ DAS-124-QA QWE-431-FS
    :skills BASIC-01 DUCK-08 POLLING-12))
)
```

This message is composed of pseudo-code that indicates settings for the subscription (e.g. the languages to be used), the identity of the engineer, his address, his times of availability, the geographical areas where he can work and his skills. The “:sender” attribute indicates the agent identifier of the DA who sends the message. The “:receiver” attribute indicates the agent identifier of the DF agent who receives the message. The “:content” attribute contains an action specification that should be performed by the receiver agent of the message. In this case, the action name is “update-preference” and the argument of the action is preference information of the mobile worker whom the DA represents. The argument of the action consists of a worker identifier (:WID eahbl00), an agent identifier of the DA (:AID da-eahbl00@mobile.com), the availability of the mobile worker during a specific week, the preferred areas worked by the mobile worker, and skills the mobile worker has. The MMA can filter the work items that it notifies to the engineer, or on which it will accept bids from the engineer, based on that information.

At a pre-set time the MMA 101 opens the market by contacting the DF to get a list of registered DAs and their preference to be used in filtering work items to be offered via CFP messages. In a specific implementation of this invention, the MMA may store the received preference information in tables in a relational database as shown in FIG. 5. In this example the table T_ScheduleMarket provides 5 fields for storing information relating to a schedule market, specifically: Mktld (a unique identifier of the ScheduleMarket), WorkDay (the work day the ScheduleMarket stands for), OpenTime (the opening time of the virtual market), ClosedTime (the market closed time), NoDAs (the number of DAs participating to the market), and Status (the current status of the operation of the market). The table T_Participants has fields to characterise participants in the schedule market. WID is a unique identifier of a mobile worker and AID is the agent identifier of the DA which represents the mobile worker. A Completed field may contain a Boolean value to represent whether the worker has a complete schedule for the working day. The fields SkillPref, AreaPref, and UrgencyPref may also contain Boolean values to represent whether the worker has preference for the skills, areas, and urgency in receiving candidate works in a CFP message. If a mobile worker has. “true” values for these preference fields then the preference details may be found from other tables, i.e. the tables T_ParticipantsSkills, T_ParticipantsArea, and T_ParticipantsUrgency respectively.

Based on the preference information stored in the tables, the MMA 101 will filter works from local work database 311 and compose CFPs (calls for proposals) messages. In a specific implementation of this invention, a CFP message has the following form.

```
(CFP
:sender (agent-identifier :name mma@mobile.com)
:receiver (set (agent-identifier :name da-eahbl00@mobile.com))
:language FIPA-SL0
:protocol FIPA-
:ontology IncentiveBasedWorkAllocation
:reply-by “09-01-2006 12:00:00”
:content (action (agent-identifier :name da-eahbl00@mobile.com)
  (compose-schedule (WID eahbl00)
    (Work (id wid0001)(bonus 10)(price ?p1)...)
    ...
    (Work (id wid010)(bonus 100)(price ?p2)(skill BASIC-
01)...)
)
```

In this pseudo code message the reply-by attribute is used to indicate the deadline by when the receiver (in this case, a DA) should respond with a “propose” message. The message content contains the list of works that match with the preference stored in the DF.

At the beginning of a schedule market, an MMA sends a CFP (Call For Proposal) to each participating DA. FIG. 4 shows a possible internal architecture of a MMA in a specific implementation of this invention. In this architecture, a session manager will be responsible for the operation of an instance of a schedule market. The creation of a CFP will be executed by interacting with a participants selector and a work filter. The participants selector returns a list of AIDs (agent identifiers) of DAs that represent the human users who are available for the target working day. The work filter returns a list of works that meet the preference constraint of a given human worker. The preferences may include work area (e.g. in the form of a list of post codes or geographical coordinates), skill set, and/or minimum value of bonus points assigned to each work. The session manager also contacts a MPDBMS (market policy database management system) to acquire a policy for setting the expiration time for each CFP message.

Once a CFP has been received, each DA composes a bid that contains a work schedule for the human worker the DA is representing. FIG. 6 shows the internal architecture of a DA. As illustrated in FIG. 6, a coordination manager will be responsible for the composure of a work schedule. The composition of a work schedule may be done by executing predefined algorithms. Any suitable algorithms can be used to compose an optimum work schedule. As an example, the composition of an optimum schedule for a work may be done by solving a mathematical model. For example, the following integer programming model may be used to select work in a schedule for a mobile worker.

```
Max Σbᵢⱼxᵢⱼ
s.t
  Σcᵢⱼxᵢⱼ <= t
  for all
```

where:
xᵢⱼ represents a route between the location for work i to the location of next work j and takes either 0 or 1. (if this value is 1, then this indicates that the worker executes work j after work i);
bᵢⱼ is the bonus point (of the work j) obtained by taking the route xᵢⱼ
cᵢⱼ=time cost occurred taking the route xᵢⱼ (the sum of travelling time from work i to work j and work execution time for work j); and
t is a time constraint.

### Alternatively a heuristic algorithm may be employed for the composition of a work schedule.

On receiving a CFP message, the coordination manager 501 will retrieve message content and pass to the model management system (MMS) 504. The MMS 504 may retrieve the current user preference on the algorithm for the composition of a work schedule from the user preference repository 505. Once, an algorithm has been chosen and retrieved from the model base 507, the MMS 504 may formulate a model by bounding the values (for example, the bonus points, travel time, job execution time, appointment time of candidate works) passed from the coordination manager 501 to the parameters of the chosen algorithm. Once the MMS 504 succeeds in formulating a model to solve, it contacts solver 503 to ask for the solution of the model. Solver 503 checks the model type and retrieve a binary execution program corresponding to the passed model from solver base 506. Solver 503 will return either a valid Work schedule or failure. If the execution result is a failure, then MMS 504 will choose an alternative model based on pre-defined user preferences and repeat the same logic. If the solver 503 returns a valid work schedule then MMS 504 will assign prices against the works in the Work schedule.

In a specific implementation of this invention, different pricing strategies may be used and configured by human users. For example, a user may want to allocate prices to the works based on the bonus points per work hour.

Once the pricing has been finished, then the MMS 504 may pass the priced schedule back to the coordination manager 501 which will compose a bid based on the priced schedule. That bid is then sent in a propose message to the MMA 101. The bid should be sent before the declared deadline (as specified in a reply-by field of the CFP message) expires, otherwise it will be ignored in the bid analysis process.

An example propose message may have following form.

```
(Propose
:sender (agent-identifier :name da-eahbl00@mobile.com)
:receiver (set (agent-identifier :name mma@mobile.com))
:language FIPA-SL0
:protocol WorkAllocation
:ontology IncentiveBasedWorkAllocation
:content (action (agent-identifier :name da-eahbl00@mobile.com)
    (compose-schedule (WID eahbl00)
        (Work (id wid0001)(price 20)(bonus 10))
        ...
        (Work (id wid010)(bonus 100)(price 5))
)
```

In the propose message, the content attribute may include only those works that are proposed to be included in the work schedule for a single mobile worker.

On the expiration of the deadline for receiving propose messages, MMA 101 collects all the received proposals and evaluate them to process any conflicts among them. First, MMA 101 stores all the proposed work schedules in a local table T_Schedules 406 as shown in FIG. 5. The “secured” field of the table indicates whether each schedule has been approved by MMA 101, which would be the case if there is no conflict between the work specified in that work schedule and the work specified in the other proposed work schedules. The “round” field indicates the round of the bidding process in which that work schedule was submitted.

The evaluation of the proposed work schedules by MMA 101 involves accepting valid non-conflicting work schedules by setting their “secured” fields, resolving conflicts between conflicting work schedules, and accepting the winning conflicting schedules by setting their “secured” fields. As discussed above, a conflict arises when more than one work schedule includes one or more of the same work items. Such conflicts are resolved using pre-defined resolution rules executed by the MMA 101. Those resolution rules are stored in a Market Policy DB 309 and accessed via a market policy DBMS 308. Examples of possible conflict resolution rules are as follows.
The winning work schedule is the one that bids to pay the highest price
The winning work schedule is the one that is submitted by the most skilled engineer
The winning work schedule is the one that is submitted by the engineer most closely located to the work
Items of work that are bundled together are assigned collectively to the work schedule that Wins the earliest in time of those bundled work items.

These rules may be combined hierarchically so that, for instance, in the event of two bids offering to pay the same price the work is awarded to the one of those bids that is submitted by the more skilled engineer.

Having accepted a work schedule or rejected a work schedule the MMA sends an accept-propose or a reject-propose message respectively to the DA that submitted that schedule. A work schedule will be accepted only if all the work items in it were secured by MMA 101. If any works within the proposed Work schedule were not secured, then the work schedule will be rejected. However, the system may allow selected work items within a work schedule to be accepted, to make the process of handling bids in subsequent rounds more efficient. This can be achieved through the provision of a suitable field in the reject-propose message.

In a specific implementation of this invention, the Accept-Propose and Reject-Propose messages may take following forms respectively.

```
(Accept-Propose
:sender (agent-identifier :name mma@mobile.com)
:receiver (set (agent-identifier :name da-eahbl00@mobile.com))
:language FIPA-SL0
:protocol WorkAllocation
:ontology IncentiveBasedWorkAllocation
:content (action (agent-identifier :name da-eahbl00@mobile.com)
    (compose-schedule (WID eahbl00))
)
(Reject-Propose
:sender (agent-identifier :name mma@mobile.com)
:receiver (set (agent-identifier :name da-eahbl00@mobile.com))
:language FIPA-SL0
:protocol WorkAllocation
:ontology IncentiveBasedWorkAllocation
:content (action (agent-identifier :name da-eahbl00@mobile.com)
    (compose-schedule (WID eahbl00))
        (Work (id wid0001)(price 20)(bonus 10)(Accepted true))
        ...
        (Work (id wid010)(bonus 100)(price 5)(Accepted false))
)
```

As shown in the above example messages, a reject-propose message may contain an additional field for each, proposed work item, which can show whether it has been accepted. If that “accepted” field is set as TRUE, that indicates that the corresponding work item has been secured by MMA 101, even though the work schedule as a whole has been rejected.

On receiving an accept-propose message, a DA 105 may store the accepted schedule in a local database so that it can respond to the PA 106 of a mobile device at a later time when the mobile device inquires as to the status of its bid(s). On receiving a reject-proposal message the DA checks each of the work items specified in the message to see which work items have been secured. Using pre-stored logic the DA can decide whether to accept the allocation of those secured items. If it does, then it signals its acceptance to the MMS and the MMS secures those work items as if they had been submitted in a revised work schedule, replacing the corresponding decision variables with an indication that the work items are secured that the decision model becomes easier to solve in followed rounds. Alternatively, if the DA does not accept their allocation then the MMS frees those work items for bidding in the next round.

After performing these tasks, the DA 105 sends an inform-done or alternatively a failure message to the PA 106, depending on the result of the tasks. An inform-done message may take following form.

```
(Inform-Done
:sender (agent-identifier :name da-eahbl00@mobile.com)
:receiver (set (agent-identifier :name mma@mobile.com))
:language FIPA-SL0
:protocol WorkAllocation
:ontology IncentiveBasedWorkAllocation
:content (action (agent-identifier :name da-eahbl00@mobile.com)
    (compose-schedule (WID eahbl00))
        (Work (id wid0001)(price 20)(bonus 10)(Accepted true))
        ...
        (Work (id wid010)(bonus 100)(price 5)(Accepted false))
)
```

When the deadline for response messages expires, the MMA 101 closes the round. It can then update local tables if it receives any failure message from a participating DAs, by updating the T_Schedules.secured field to “false” for any works previously secured to such DAs.

After a round has been closed, the MMA can start the next round by sending another set of CFP messages to those DAs that did not secure enough work items to fill their available working time for the period in question. As described above, such CFP messages do not include works previously secured by the MMA 101 in previous rounds. This process continues until all DAs are fully occupied for the period in question, or all available work items have been allocated, or until a pre-set limiting number of rounds have been completed.

The example described above relates to the allocation of work items to mobile engineers. However, the present invention is applicable to many other allocation situations. It could be used to allocate human, automated or other resources to required services. The required services could include the take-up of available goods or services, and thus the same mechanism could be used for auctioning collections, of items.

Each of the MMA, the DAs and the PAs can be implemented as a hardware and/or software entity. The MMA and the DAs may be located on a central computing device or server, which could for instance be implemented on a Sun Sparc unit or a PC. On the other hand, the PAs are preferably implemented on mobile devices such as mobile phones or PDAs (personal digital assistants). Those devices can preferably communicate with the MMA and/or the DAs via a wireless communication system such as a mobile phone network or a wireless local area network (WLAN). In this way an engineer can carry a PA with him when he is working in the field and can use it to bid for jobs as well as to receive instructions on which jobs to carry out.

This invention could be implemented by means of a multi-agent system platform such as Jade-LEAP.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the, art that various modifications may be made within the scope of the invention.

1. A method for allocating service providers to a set of required services, each, service provider being associated with a respective bidding entity and the method comprising repeatedly performing the following steps:
receiving at least one bid from each of some or all of the bidding entities, each bid specifying one or more of the required services and indicating a bid value;
accepting bids that specify no services that are specified in any other bids;
for any sets of bids that specify one or more of the same services, selecting one of those bids in dependence on the bid values specified in each bid of the set, and accepting the selected bid; and
removing the services specified in accepted bids from the list of required services.

2. A method as claimed in claim 1, wherein: the said steps of receiving, accepting, selecting and removing are performed by a data processing unit; each bidding entity operates under the control of a mobile communication unit; and the bidding entities are connected to the data processing unit by first communication means that are more reliable than second communication means by means of which the mobile communication units can communicate with the bidding entities.

3. A method as claimed in claim 2, wherein the second communication means comprises a wireless communication link.

4. A method as claimed in any preceding claim, wherein the step of selecting one of the bids of a set in dependence on the bid values specified in each bid of the set comprises determining which of the bids of the set specifies a bid value closest to a pre-set limit value and accepting that bid.

5. A method as claimed in any preceding claim, comprising the step of rewarding each service provider in dependence on the bid values specified in accepted bids received from the bidding entity associated with the respective service provider.

6. A method as claimed in any preceding claim, comprising the steps of:
allocating a service value to each of the required services; and
rewarding each service provider in dependence on the service values of the services performed by the respective service provider.

7. A method as claimed in any preceding claim, comprising:
storing information representing attributes of each service provider; and
the step of selecting one of the bids of a set is performed in dependence also on the attribute information stored for each of the service providers associated with the bidding entities that submitted the bids of the set.

8. A method as claimed in any preceding claim, wherein each bidding entity is independently configurable to, on receiving a request for a bid, automatically form a bid in accordance with a bidding algorithm supplied to it.

9. A method as claimed in claim 8, wherein the method comprises:
receiving at a bidding entity a list of required services;
the bidding entity automatically selecting at least some of those services in accordance with the bidding algorithm supplied to it;
the bidding entity determining a bid value in dependence on the selected services and the bidding algorithm; and
the bidding entity transmitting a bid specifying the selected services and indicating the determined bid value.

10. A system for allocating service providers to a set of required services, each service provider being associated with a respective bidding entity, the system comprising an allocation unit configured to repeatedly perform the following steps:
receiving at least one bid from each of some or all of the bidding entities, each bid specifying one or more of the required services and indicating a bid value;
accepting bids that specify no services that are specified in any other bids;
for any sets of bids that specify one or more of the same services, selecting one of those bids in dependence on the bid values specified in each bid of the set, and accepting the selected bid; and
removing the services specified in accepted bids from the list of required services.

11. A system as claimed in claim 10, wherein the allocation unit comprises a data processing unit; each bidding entity operates under the control of a mobile communication unit; and the bidding entities are connected to the data processing unit by first communication means that are more reliable than second communication means by means of which the mobile communication units can communicate with the bidding entities.

12. A system as claimed in claim 11, wherein the second communication means comprises a wireless communication link.

13. A system as claimed in any of claims 10 to 12, wherein the step of selecting one of the bids of a set in dependence on the bid values specified in each bid of the set comprises determining which of the bids of the set specifies a bid value closest to a pre-set limit value and accepting that bid.

14. A system as claimed in any of claims 10 to 13, wherein the allocation unit stores information representing attributes of each service provider and is configured to select one of the bids of a set in dependence also on the attribute information stored for each of the service providers associated with the bidding entities that submitted the bids of the set.

15. A system as claimed in any of claims 10 to 14, wherein each bidding entity is independently configurable to, on receiving a request for a bid, automatically form a bid in accordance with a bidding algorithm supplied to it.

16. A system as claimed in claim 15, wherein each bidding entity is configured to:
receive a list of required services;
automatically selecting at least some of those services in accordance- with the bidding algorithm supplied to it;
determined a bid value in dependence on the selected services and the bidding algorithm; and
transmit to the allocation unit a bid specifying the selected services and indicating the determined bid value.
